(19) United States
(12) Patent Application Publication
(10) Pub. No.: US 2025/0358046 A1
(43) Pub. Date: Nov. 20, 2025

(54) Controller, Target, and Communication System

(71) Applicant: ROHM CO., LTD., Kyoto (JP)

(72) Inventor: Tatsuhiko MURATA, Kyoto (JP)

(21) Appl. No.: 19/201,473

(22) Filed: May 7, 2025

(30) Foreign Application Priority Data
May 16, 2024 (JP) 2024-080150

(51) Int. Cl. H04L 1/00; G06F 13/42

(52) U.S. Cl. CPC H04L 1/0061; G06F 13/4282

(57) ABSTRACT

A controller is configured to perform a serial communication with a target, and comprises an arithmetic circuit configured to calculate a CRC value of a signal sequence including an address of the target, an address of a storage circuit of the target, and a write data when the controller performs data writing to the storage circuit, and a communication circuit configured to transmit the address of the target, the address of the storage circuit, the write data, and the CRC value to the target. The arithmetic circuit is configured to hold a calculation value during a calculation when a positive acknowledgment is returned from the target.

### TECHNICAL FIELD

The present disclosure relates to a controller, a target, and a communication system.

### BACKGROUND

A CRC (Cyclic Redundancy Check) value is used to verify whether data sent from a sender to a receiver is sent correctly (refer to, for example, Patent Document 1).

### PRIOR ART DOCUMENT

### Patent Document

[Patent document 1] Japan Patent Publication No. 2010-16751.

### BRIEF DESCRIPTION OF THE DRAWINGS

FIG. 1 is a diagram showing a communication protocol for data writing according to a comparative example.

FIG. 2 is a diagram showing a communication protocol for data reading according to a comparative example.

FIG. 3 is a diagram showing a communication protocol for data writing according to an embodiment of the present disclosure.

FIG. 4 is a diagram showing a communication protocol for data reading according to an embodiment of the present disclosure.

FIG. 5 is a diagram showing a configuration example of a communication system according to an embodiment of the present disclosure.

FIG. 6 is a diagram showing a configuration example of an arithmetic circuit.

FIG. 7 is a diagram for illustrating an operation of an arithmetic circuit.

FIG. 8 is a diagram for illustrating operations of a first arithmetic circuit and a second arithmetic circuit.

FIG. 9 is a diagram showing a communication protocol in multiple modes for data writing according to an embodiment of the present disclosure.

FIG. 10 is a diagram showing a communication protocol in multiple modes for data reading according to an embodiment of the present disclosure.

### DETAILED DESCRIPTION OF THE EMBODIMENTS

### Comparative Example

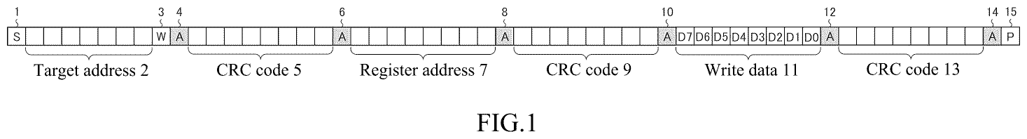

FIG. 1 is a diagram showing a communication protocol for data writing according to a comparative example. Furthermore, communication protocols of the comparative examples and embodiments described below comply with an I2C communication standard. Additionally, in each diagram showing the communication protocol, each block represents a 1-bit signal, with white blocks representing signals sent from a controller to a target, and gray blocks representing signals sent from the target to the controller.

In the communication protocol shown in FIG. 1, signals are sent in an order of a start condition 1, a target address 2, a data write indication signal 3, a positive acknowledgment 4, a CRC code (CRC value) 5, a positive acknowledgment 6, a register address 7, a positive acknowledgment 8, a CRC code 9, a positive acknowledgment 10, a write data 11, a positive acknowledgment 12, a CRC code 13, a positive acknowledgment 14, and a stop condition 15.

The CRC code 5 is a result of a CRC calculation on the target address 2 and the data write indication signal 3. The CRC code 9 is a result of a CRC calculation on the register address 7. The CRC code 13 is a result of a CRC calculation on the write data 11.

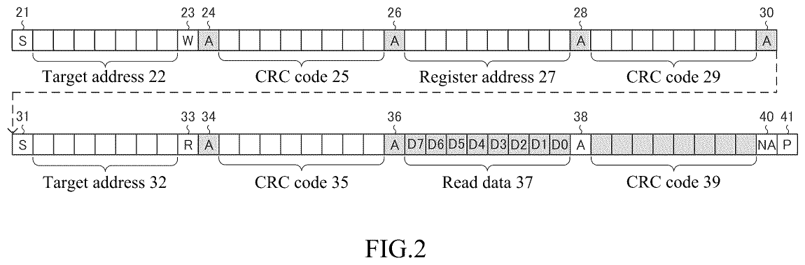

FIG. 2 is a diagram showing a communication protocol for data reading according to a comparative example.

In the communication protocol shown in FIG. 2, signals are transmitted in an order of a start condition 21, a target address 22, a data write indication signal 23, a positive acknowledgment 24, a CRC code 25, a positive acknowledgment 26, a register address 27, a positive acknowledgment 28, a CRC code 29, a positive acknowledgment 30, a start condition 31, a target address 32, a data read indication signal 33, a positive acknowledgment 34, a CRC code 35, a positive acknowledgment 36, a read data 37, a positive acknowledgment 38, a CRC code 39, a negative acknowledgment 40, and a stop condition 41.

The CRC code 25 is a result of a CRC calculation on the target address 22 and the data write indication signal 23. The CRC code 29 is a result of a CRC calculation on the register address 27. The CRC code 35 is a result of a CRC calculation on the target address 32 and the data read indication signal 33. The CRC code 39 is a result of a CRC calculation on the read data 37.

In the comparative example, not only data errors but also address errors can be detected, and an improvement in communication quality can be achieved. However, in the comparative example, during data writing, the CRC value for the signal sequence including the target address, the CRC value for the register address, and the CRC value for the write data are calculated individually. Additionally, during data reading, the CRC value for the signal sequence including the target address, the CRC value for the register address, and the CRC value for the read data are calculated individually. Therefore, in the comparative example, the number of CRC values sent increases, and the communication efficiency is significantly reduced. Such an issue can be resolved by the embodiment described below.

### Embodiments

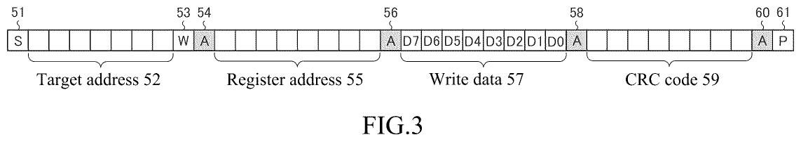

FIG. 3 is a diagram showing a communication protocol for data writing according to an embodiment of the present disclosure.

In the communication protocol shown in FIG. 3, signals are transmitted in the order of

a start condition 51, a target address 52, a data write indication signal 53, a positive acknowledgment 54, a register address 55, a positive acknowledgment 56, a write data 57, a positive acknowledgment 58, a CRC code 59, a positive acknowledgment 60, and a stop condition 61.

The CRC code 59 is a result of a CRC calculation on the target address 52, the data write indication signal 53, the register address 55, and the write data 57.

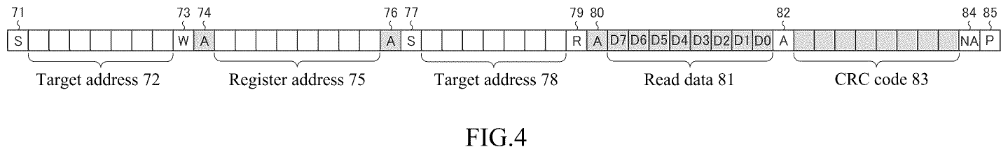

FIG. 4 is a diagram showing a communication protocol for data reading according to an embodiment of the present disclosure.

In the communication protocol shown in FIG. 4, signals are transmitted in the order of a start condition 71, a target address 72, a data write indication signal 73, a positive acknowledgment 74, a register address 75, a positive acknowledgment 76, a start condition 77, a target address 78, a data read indication signal 79, a positive acknowledgment 80, a read data 81, a positive acknowledgment 82, a CRC code 83, a negative acknowledgment 84, and a stop condition 85.

The CRC code 83 is a result of a CRC calculation on the target address 72, the data write indication signal 73, the register address 75, the target address 78, the data read indication signal 79, and the read data 81.

In the embodiments of the present disclosure, not only data errors but also address errors can be detected, and an improvement in communication quality can be achieved. Additionally, in the embodiments of the present disclosure, during data writing, the CRC value of the signal sequence including the target address, the register address, and the write data is calculated. Additionally, in the embodiments of the present disclosure, during data reading, the CRC value of the signal sequence including the target address, the register address, and the read data is calculated. Therefore, in the embodiments of the present disclosure, the increase in the CRC values sent can be suppressed, and a decrease in communication efficiency can be suppressed.

FIG. 5 is a diagram showing a configuration example of a communication system according to an embodiment of the present disclosure. A communication system SYS1 shown in FIG. 5 comprises a controller CNT1 and targets TG1 and TG2. The targets TG1 and TG2 are each assigned a unique address. Although the number of targets in the communication system SYS1 shown in FIG. 5 is two, the number of targets is not limited to two, and may be one or may be three or more. In the following description, when it is not necessary to distinguish between the target TG1 and the target TG2, the targets TG1 and TG2 may each be referred to as a target TG.

The controller CNT1 is formed of, for example, a CPU (Central Processing Unit). The controller CNT1 comprises an arithmetic circuit 101 and a communication circuit 102.

The arithmetic circuit 101 calculates a CRC value of a signal sequence including an address of the target TG with which it is communicating, an address of a register 2101 built in the target TG with which it is communicating, and a write data. That is, the arithmetic circuit 101 calculates the CRC code 59 shown in FIG. 3.

The communication circuit 102 generates a clock signal and synchronizes a transmission and a reception of the signal sequence (serial data signal) shown in FIG. 3 and the signal sequence (serial data signal) shown in FIG. 4, which are sent via a second signal line SL2, with the clock signal. Additionally, the communication circuit 102 outputs the generated clock signal to a first signal line SL1.

The controller CNT1 verifies whether there is an error in the target address 72, the data write indication signal 73, the register address 75, the target address 78, and the data read indication signal 79 received by the target TG, and the read data 81 received by the controller CNT1, using the CRC code 83. Specifically, the controller CNT1 calculates the CRC code from the target address 72, the data write indication signal 73, the register address 75, the target address 78, and the data read indication signal 79 sent to the target TG, and the read data 81 received by the controller CNT1, and determines that there is an error when the calculated CRC code does not match the CRC code 83.

The target TG is formed of, for example, LSI (Large Scale Integration). The target TG comprises a register 201, an arithmetic circuit 202, and a communication circuit 203.

The register 201 is a storage circuit capable of writing data and reading data. Furthermore, the target TG may comprise a storage circuit other than the register 201 instead of the register 201.

The arithmetic circuit 202 calculates a CRC value of a signal sequence including an address of the target TG equipped with itself, an address of the register 201 built in the target TG equipped with itself, and the read data. That is, the arithmetic circuit 101 calculates the CRC code 83 shown in FIG. 4. The arithmetic circuit 202 includes a first arithmetic circuit 202A and a second arithmetic circuit 202B. Details of the first arithmetic circuit 202A and the second arithmetic circuit 202B are described below.

The communication circuit 203 receives the clock signal output from the controller CNT1 and synchronizes a transmission and a reception of the signal sequence (serial data signal) shown in FIG. 3 and the signal sequence (serial data signal) shown in FIG. 4, which are sent via the second signal line SL2, with the clock signal.

The target TG verifies whether there is an error in the target address 52, the data write indication signal 53, the register address 55, and the write data 57 received by the target TG using the CRC code 59. Specifically, the target TG calculates the CRC code from the target address 52, the data write indication signal 53, the register address 55, and the write data 57 received by the target TG, and determines that there is an error when this calculated CRC code does not match the CRC code 59.

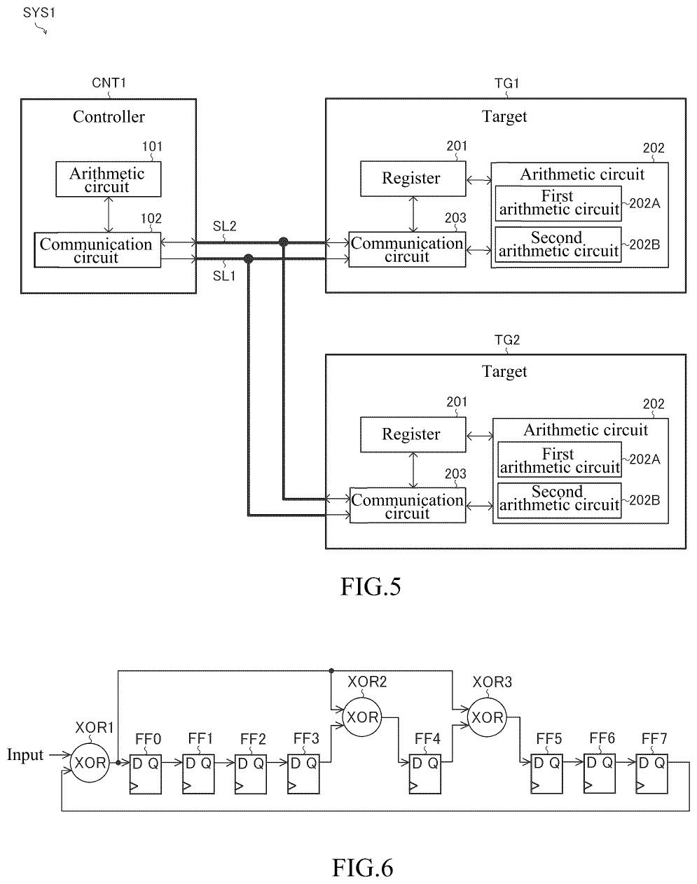

FIG. 6 is a diagram showing a configuration example of the arithmetic circuit 101. The arithmetic circuit 101 in the configuration example shown in FIG. 6 comprises flip-flops FF0 to FF7 and exclusive OR circuits XOR1 to XOR3, and performs data processing serially. The configuration example of the first arithmetic circuit 202A is also the configuration example shown in FIG. 6, and the configuration example of the second arithmetic circuit 202B is also the configuration example shown in FIG. 6. The clock input terminals of the flip-flops FF0 to FF7 are supplied with the clock signal generated in the communication circuit 102.

In the arithmetic circuit of the configuration example shown in FIG. 6, initial values of signals output from each output terminal of the flip-flops FF0 to FF7 are all 0. Thus, the initial value of the CRC code calculated by the arithmetic circuit of the configuration example shown in FIG. 6 is 00000000. When the arithmetic circuit of the configuration example shown in FIG. 6 performs a reset operation, the CRC code calculated by the arithmetic circuit of the configuration example shown in FIG. 6 is reset to the initial value.

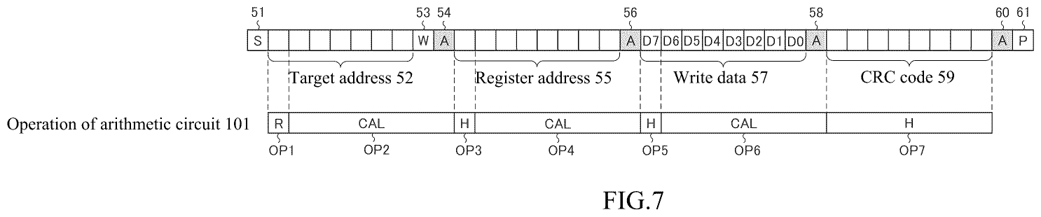

FIG. 7 is a diagram for illustrating an operation of the arithmetic circuit 101. The arithmetic circuit 101 performs the operation shown in FIG. 7 when the controller CNT1 writes data to the register 201 of the target TG.

The arithmetic circuit 101 performs a reset operation OP1 in a cycle where the flip-flops FF0 to FF7 store the data supplied to their own input terminals in a state wherein the start condition 51 is being input to the arithmetic circuit 101. After the reset operation OP1, the arithmetic circuit 101 performs a normal arithmetic operation OP2.

After the arithmetic operation OP2, the arithmetic circuit 101 performs a holding operation OP3 that holds a calculation value during a calculation in a cycle where the flip-flops FF0 to FF7 store the data supplied to their own input terminals in a state wherein the positive acknowledgment 54 is being input to the arithmetic circuit 101. In the holding operation OP3, the flip-flops FF0 to FF7 supply the data output from their own output terminals to their own input terminals. After the holding operation OP3, the arithmetic circuit 101 performs a normal arithmetic operation OP4.

After the arithmetic operation OP4, the arithmetic circuit 101 performs a holding operation OP5 that holds a calculation result in a cycle where the flip-flops FF0 to FF7 store the data supplied to their own input terminals in a state wherein the positive acknowledgment 56 is being input to the arithmetic circuit 101. In the holding operation OP5, the flip-flops FF0 to FF7 supply the data output from their own output terminals to their own input terminals. After the holding operation OP5, the arithmetic circuit 101 performs a normal arithmetic operation OP6.

After the arithmetic operation OP6, the arithmetic circuit 101 starts a holding operation OP 7 that holds a calculation result (CRC code 59) in a cycle where the flip-flops FF0 to FF7 store the data supplied to their own input terminals in a state wherein the positive acknowledgment 56 is being input to the arithmetic circuit 101. The holding operation OP7 continues until the output of the CRC code 59 from the arithmetic circuit 101 is completed.

The arithmetic circuit 101 may perform any operation during a period other than the periods during which the operations OP1 to OP7 are performed.

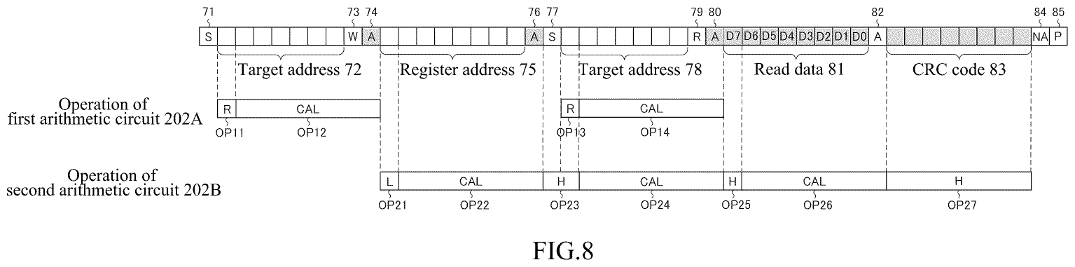

FIG. 8 is a diagram for illustrating operations of the first arithmetic circuit 202A and the second arithmetic circuit 202B. The first arithmetic circuit 202A and the second arithmetic circuit 202B perform the operations shown in FIG. 8 when the controller CNT1 reads data from the register 201 of the target TG.

The arithmetic circuit 202A performs a reset operation OP11 in a cycle where the flip-flops FF0 to FF7 store the data supplied to their own input terminals in a state wherein the start condition 71 is being input to the arithmetic circuit 202A. After the reset operation OP11, the arithmetic circuit 202A starts a normal calculation operation OP12. The calculation operation OP12 continues until a cycle immediately before a cycle where the flip-flops FF0 to FF7 store the data supplied to their own input terminals in a state wherein the positive acknowledgment 74 is being input to the arithmetic circuit 202A.

The arithmetic circuit 202A performs a reset operation OP13 in a cycle where the flip-flops FF0 to FF7 store the data supplied to their own input terminals in a state wherein the start condition 77 is being input to the arithmetic circuit 202A. After the reset operation OP13, the arithmetic circuit 202A starts a normal calculation operation OP14. The calculation operation OP14 continues until a cycle immediately before a cycle where the flip-flops FF0 to FF7 store the data supplied to their own input terminals in a state wherein the positive acknowledgment 80 is being input to the arithmetic circuit 202A.

The arithmetic circuit 202A may perform any operation during a period other than the periods during which the operations OP11 to OP14 are performed.

The arithmetic circuit 202B performs a load operation OP21 in a cycle where the flip-flops FF0 to FF7 store the data supplied to their own input terminals in a state wherein the positive acknowledgment 74 is being input to the arithmetic circuit 202B. In the load operation OP21, the arithmetic circuit 202B receives a calculation value during a calculation performed by the arithmetic circuit 202A. Thus, immediately after the arithmetic circuit 202B completes the load operation OP21, the data stored in the flip-flops FF0 to FF7 of the arithmetic circuit 202A completely matches the data stored in the flip-flops FF0 to FF7 of the arithmetic circuit 202B. After the load operation OP21, the arithmetic circuit 202B performs a normal calculation operation OP22.

After the calculation operation OP22, the arithmetic circuit 202B performs a holding operation OP23 that holds a calculation value during a calculation in a cycle where the flip-flops FF0 to FF7 store the data supplied to their own input terminals in a state wherein the positive acknowledgment 76 is being input to the arithmetic circuit 202B and in a cycle where the flip-flops FF0 to FF7 store the data supplied to their own input terminals in a state wherein the start condition 77 is being input to the arithmetic circuit 202B. In the holding operation OP23, the flip-flops FF0 to FF7 supply the data output from their own output terminals to their own input terminals. After the holding operation OP23, the arithmetic circuit 202B performs a normal calculation operation OP24.

After the calculation operation OP24, the arithmetic circuit 202B performs a holding operation OP25 that holds a calculation result in a cycle where the flip-flops FF0 to FF7 store the data supplied to their own input terminals in a state wherein the positive acknowledgment 80 is being input to the arithmetic circuit 202B. In the holding operation OP25, the flip-flops FF0 to FF7 supply the data output from their own output terminals to their own input terminals. After the holding operation OP25, the arithmetic circuit 202B performs a normal calculation operation OP26.

After the calculation operation OP26, the arithmetic circuit 202B starts a holding operation OP27 that holds a calculation result (CRC code 83) in a cycle where the flip-flops FF0 to FF7 store the data supplied to their own input terminals in a state wherein the positive acknowledgment 82 is being input to the arithmetic circuit 202B. The holding operation OP27 continues until the output of the CRC code 83 from the arithmetic circuit 202B is completed.

The arithmetic circuit 202B may perform any operation during periods other than the periods during which the operations OP21 to OP27 are performed.

### Other

The above embodiments should be considered exemplary in all respects and not restrictive, and the technical scope of the present disclosure is indicated by the claims rather than the description of the above embodiments, and should be understood that all modifications within the meaning and range of equivalency of the claims are included.

For example, although a single-mode communication protocol is adopted in the above embodiments, a multiple-mode communication protocol may be adopted.

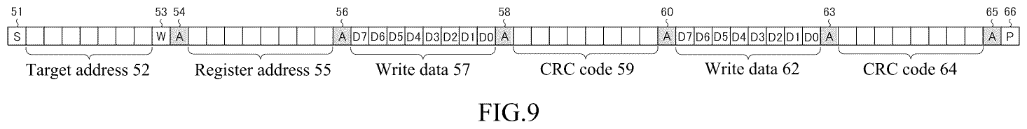

FIG. 9 is a diagram showing a communication protocol in multiple modes of data writing according to an embodiment of the present disclosure. The communication protocol shown in FIG. 9 differs from the communication protocol shown in FIG. 3 in that what follow the positive acknowledgment 60 are a write data 62, a positive acknowledgment 63, a CRC code 64, a positive acknowledgment 65, and a stop condition 66, but the communication system SYS1 may have the same circuit configuration as in the single mode. The CRC code 64 is a result of a CRC calculation on the write data 62. Furthermore, in the communication protocol shown in FIG. 9, although there are two pieces of write data, there may be three or more pieces of write data in the multiple modes.

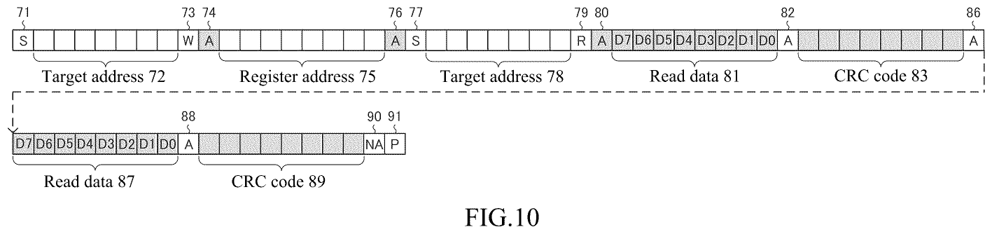

FIG. 10 is a diagram showing a communication protocol in multiple modes of data reading according to an embodiment of the present disclosure. The communication protocol shown in FIG. 10 differs from the communication protocol shown in FIG. 4 in that what follow the CRC code 83 are a positive acknowledgment 86, a read data 87, a positive acknowledgment 88, a CRC code 89, a negative acknowledgment 90, and a stop condition 91, but the communication system SYS1 may have the same circuit configuration as in the single mode. The CRC code 89 is a result of a CRC calculation on the read data 87. Furthermore, in the communication protocol shown in FIG. 10, although there are two pieces of read data, there may be three or more pieces of read data in the multiple modes.

### Appendix

The Appendix is provided for the present disclosure in which the specific configuration examples are shown in the above embodiments

A controller (CNT1) of the present disclosure is a configuration (first configuration) in which is configured to perform a serial communication with a target (TG1, TG2), and comprises an arithmetic circuit (101) configured to calculate a CRC value of a signal sequence including an address of the target, an address of a storage circuit (201) of the target, and a write data when the controller performs data writing to the storage circuit, and a communication circuit (102) configured to transmit the address of the target, the address of the storage circuit, the write data, and the CRC value to the target, wherein the arithmetic circuit is configured to hold a calculation value during a calculation when a positive acknowledgment is returned from the target.

According to the controller of the above first configuration, since the CRC value of the signal sequence including the address of the target, the address of the storage circuit, and the write data is calculated, not only data errors but also address errors can be detected, and an improvement in communication quality can be achieved. Additionally, according to the controller of the above first configuration, since the CRC value of the signal sequence including the address of the target, the address of the storage circuit, and the write data is calculated, compared to the case where the CRC value of the signal sequence including the address of the target, the CRC value of the address of the storage circuit, and the CRC value of the write data are calculated individually, the decrease in communication efficiency can be suppressed.

The controller of the above first configuration may be a configuration (second configuration) in which the target and the controller are connected via a first signal line (SL1) configured to send a clock signal output from the controller and a second signal line (SL2) configured to send a serial data signal synchronized with the clock signal, and the arithmetic circuit may be configured to receive the serial data signal.

The target (TG1, TG2) of the present disclosure is a configuration (third configuration) which is configured to perform a serial communication with a controller (CNT1), and comprises an arithmetic circuit (202) configured to calculate a CRC value of a signal sequence including an address of the target, an address of a storage circuit (201) of the target, and a read data when the controller performs data reading from the storage circuit, and a communication circuit (203) configured to transmit the read data and the CRC value to the controller, wherein the arithmetic circuit includes a first arithmetic circuit (202A) and a second arithmetic circuit (202B), the first arithmetic circuit and the second arithmetic circuit are each configured to perform CRC calculations on the received signal sequence, the first arithmetic circuit is configured to perform a reset operation at a start condition of the serial communication, and the second arithmetic circuit is configured to receive a calculation value during a calculation performed by the first arithmetic circuit at a timing when the target returns a positive acknowledgment to the address of the target that was first received, and to avoid a reset operation at the start condition of the serial communication.

According to the target of the above third configuration, since the CRC value of the signal sequence including the address of the target, the address of the storage circuit, and the read data is calculated, not only data errors but also address errors can be detected, and an improvement in communication quality can be achieved. Additionally, according to the target of the above third configuration, since the CRC value of the signal sequence including the address of the target, the address of the storage circuit, and the read data is calculated, compared to the case where the CRC value of the signal sequence including the address of the target, the CRC value of the address of the storage circuit, and the CRC value of the read data are calculated individually, the decrease in communication efficiency can be suppressed.

The target of the above third configuration may be a configuration (fourth configuration) in which the second arithmetic circuit is configured to hold the calculation value during the calculation when a positive acknowledgment is returned to the controller and when the controller outputs the start condition of the serial communication, respectively.

The target of the above third or fourth configuration may be a configuration (fifth configuration) in which the target and the controller are connected via a first signal line configured to send a clock signal output from the controller and a second signal line configured to send a serial data signal synchronized with the clock signal, and the first arithmetic circuit is configured to receive the serial data signal.

A communication system (SYS1) according to one aspect of the present disclosure is a configuration (sixth configuration) which comprises the controller of the above first or second configuration and the target, wherein the target is configured to verify whether there is an error in the address of the target and the address of the storage circuit received by the target, and the read data received by the controller using the CRC value.

A communication system (SYS1) according to another aspect of the present disclosure is a configuration (seventh configuration) which comprises the target of any one of the above third to fifth configurations and the controller, wherein the controller is configured to verify whether there is an error in the address of the target, the address of the storage circuit, and the read data, which are received by the controller, using the CRC value.

1. A controller, configured to perform a serial communication with a target, comprising:
an arithmetic circuit configured to calculate a CRC value of a signal sequence including an address of the target, an address of a storage circuit of the target, and a write data when the controller performs data writing to the storage circuit; and
a communication circuit configured to transmit the address of the target, the address of the storage circuit, the write data, and the CRC value to the target,
wherein the arithmetic circuit is configured to hold a calculation value during a calculation when a positive acknowledgment is returned from the target.

2. The controller of claim 1, wherein the target and the controller are connected via a first signal line configured to send a clock signal output from the controller and a second signal line configured to send a serial data signal synchronized with the clock signal, and the arithmetic circuit is configured to receive the serial data signal.

3. A target, configured to perform a serial communication with a controller, comprising:
an arithmetic circuit configured to calculate a CRC value of a signal sequence including an address of the target, an address of a storage circuit of the target, and a read data when the controller performs data reading from the storage circuit; and
a communication circuit configured to transmit the read data and the CRC value to the controller,
wherein the arithmetic circuit includes a first arithmetic circuit and a second arithmetic circuit,
the first arithmetic circuit and the second arithmetic circuit are each configured to perform CRC calculations on the received signal sequence,
the first arithmetic circuit is configured to perform a reset operation at a start condition of the serial communication, and
the second arithmetic circuit is configured to receive a calculation value during a calculation performed by the first arithmetic circuit at a timing when the target returns a positive acknowledgment to the address of the target that was first received, and to avoid a reset operation at the start condition of the serial communication.

4. The target of claim 3, wherein the second arithmetic circuit is configured to hold the calculation value during the calculation when a positive acknowledgment is returned to the controller and when the controller outputs the start condition of the serial communication, respectively.

5. The target of claim 3, wherein the target and the controller are connected via a first signal line configured to send a clock signal output from the controller and a second signal line configured to send a serial data signal synchronized with the clock signal, and
the first arithmetic circuit is configured to receive the serial data signal.

6. A communication system, comprising the controller of claim 1 and the target,
wherein the target is configured to verify whether there is an error in the address of the target, the address of the storage circuit, and the write data received by the target using the CRC value.

7. A communication system, comprising the target of claim 3 and the controller,
wherein the controller is configured to verify whether there is an error in the address of the target and the address of the storage circuit received by the target, and the read data received by the controller using the CRC value.
